(19) United States
(12) Patent Application Publication
(10) Pub. No.: US 2006/0218268 A1
(43) Pub. Date: Sep. 28, 2006

(54) Method and apparatus for extending service mediation to intelligent voice-over-IP endpoint terminals

(76) Inventors: Andre Beck, Woodbridge, NJ (US); Markus Andreas Hofmann, Fair Haven, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/091,877

(22) Filed: Mar. 28, 2005

(51) Int. Cl. G06F 15/173

(52) U.S. Cl. 709/224

(57) ABSTRACT

In a VoIP network, based on a set of predetermined rules, a determination is made whether the running of an endpoint-hosted service on an intelligent VoIP endpoint and the running of a network-hosted service could cause a conflict to arise if both services were invoked during a call/session. If a determination is made that a conflict could arise between the endpoint-hosted service and the network-hosted service, then either the intelligent endpoint is instructed not to invoke the endpoint-hosted service during a call/session or to only invoke it with certain restrictions that would avoid the conflict, or alternatively, the network service is not invoked or is only invoked with certain restrictions that would avoid the conflict.

### TECHNICAL FIELD

This invention relates to Voice-over-IP (VoIP) networks, and more particularly, to avoiding conflict between services that are provided from within the VoIP network and services that are provided by intelligent VoIP endpoint terminals.

### BACKGROUND OF THE INVENTION

Historically, telephony networks have been designed around “dumb” endpoints that require all services to be provided from inside the network. This assumption shaped the architectural design of today's telephone networks and the technology used therein. With the advent of packet-based telephony, however, the world is about to undergo a dramatic and disruptive change. This change is caused by the fact that VoIP protocols like the Session Initiation Protocol (SIP) adhere to the “end-to-end” principle, which suggests that the network should be kept as simple as possible and that all intelligence should reside in the end systems. When applied to telephony networks, this means that a VoIP-based telephone infrastructure will bring about a paradigm shift from a network-centric to an endpoint-centric design.

Endpoint vendors are taking advantage of this fact by deploying intelligent VoIP phones, which provide services that were formerly hosted inside the network. For example SIP phones are available that support features such as call forwarding, call transfer, three-way conferencing, and call logging. Other phones are available, which support a Java-based runtime environment that can host even more services and applications. Even further, a full-featured SIP endpoint terminal can be integrated into the Windows operating system, turning every PC into a sophisticated, easily programmable phone.

When the services that are being provided to an endpoint are all network hosted, service mediation by a network function is employed to prevent unintended service or feature interactions, which can occur when multiple services operate simultaneously without being aware of each other. For example, unintended results can occur when one service interferes with the normal and desired operation of another service. Service mediation through a Service Mediation Function (SMF) in the network prevents such interference by mediating between two potentially conflicting services. In its simplest forms, service mediation applies a number of static rules to determine which services are to be invoked under which conditions. A more advanced type of service mediation may also take into consideration certain network or service events for dynamically determining how to prevent service interaction conflicts.

A network-based SMF generally requires a certain set of capabilities as well as manual configuration. The SMF must usually be provisioned with two types of rules: 1) rules specifying what constitutes interaction conflicts; and 2) rules specifying acceptable ways of preventing or resolving conflicts. In order to detect conflicts, the network-based SMF needs to either be notified of service invocation requests or be stoically configured with rules specifying under which conditions services may be invoked. Lastly, the SMF needs to have the ability to suppress or otherwise modify service invocation requests.

Whereas service mediation from within the network between network-hosted services is able to avoid undesirable service interactions in telephony networks, as noted above, in the next-generation VoIP networks, many services that traditionally have been provided by network elements are now likely be hosted by intelligent VoIP endpoints. For example as noted above, call forwarding and call logging services, are services that can be hosted by a VoIP endpoint. This trend towards endpoint-hosted services in VoIP networks complicates the service mediation problem between endpoint-hosted services and network-hosted services. With both such services running concurrently, interaction conflicts between endpoint-hosted services and network-hosted services cannot be resolved with existing service mediation solutions for at least two reasons. Firstly, existing network-based service mediation solutions are entirely unaware of any services being hosted by endpoints; and, secondly, existing service mediation solutions have no control over endpoint-hosted services. Accordingly, a mechanism is needed for discovering and controlling endpoint-hosted services in order to prevent conflicts between such endpoint-hosted services and network-hosted services in a VoIP network.

### SUMMARY OF THE INVENTION

Based on a set of predetermined rules, a determination is made whether, if both services are invoked during a call/session, a conflict could arise between an endpoint-hosted service that is installed on an intelligent VoIP endpoint and a VoIP network-hosted service to which that intelligent endpoint also subscribes. If a determination is made that a conflict could arise between the endpoint-hosted service and the network-hosted service, then either the intelligent endpoint is instructed not to invoke the endpoint-hosted service during a call/session or to only invoke it with certain restrictions that would avoid the conflict, or alternatively, the network service is not invoked or is only invoked with certain restrictions that would avoid the conflict.

In an exemplary embodiment of the invention, within a VoIP network in which the SIP protocol is employed, a service broker acts as an intermediary between the endpoints of a call/session, providing the Service Mediation Function. The service broker learns the particular endpoint-hosted services to which an intelligent endpoint is subscribed through various possible mechanisms. For example, the service broker can request this information as part of a SIP INVITE request sent to the endpoint to initiate a call/session, or as a separate message sent to the endpoint by the service broker. In response to the request, the intelligent endpoint provides information relating to its service capabilities to the service broker. This information can be provided to the service broker on a call-by-call basis at the beginning of a call/session, or in the middle of a call/session if a service is invoked during a call/session. Alternatively, the endpoint can be configured to automatically send its service capabilities to the service broker when it registers with the network so that the service broker statically stores information. If the service broker is located within the VoIP network, it is made aware which network-based services the endpoint is subscribed to either through a manual configuration or by querying a network database. The service broker, knowing both the endpoint-hosted services and network-hosted services that could be invoked during a call/session, performs the Service Mediation Function by applying predetermined rules to determine what in fact constitutes a conflict. It then determines how to resolve or prevent that conflict and instructs the endpoint-hosted service and/or the network-hosted service not to invoke a specific service or to invoke a specific service with certain restrictions so as to avoid the determined conflict. In this embodiment, the service broker can be a separate entity or can be integrated within the SIP proxy.

In an alternative embodiment, rather than being located within the VoIP network, the service broker could be co-located with or integrated with the endpoint. In such an arrangement, since the service broker is aware of which endpoint-hosted services that its associated endpoint is capable of invoking, it queries the network to determine to which active network-hosted services that endpoint subscribes. If a conflict between services is determined to exist, the endpoint-located service broker instructs the network to not run a network-hosted service that will be in conflict with an endpoint-hosted service, or to run the network-hosted service only with certain restrictions so as to avoid the conflict, and/or instructs the endpoint to not run a endpoint-hosted service that will be in conflict with a network service, or to run it only with certain restrictions so as to avoid the conflict.

The exemplary embodiments can be implemented using, for example, the SIP Session Policy Framework currently being developed by the SIP community.

### BRIEF DESCRIPTION OF THE DRAWING

FIG. 1 is a block diagram of a prior art VoIP network in which a conflict can arise between an endpoint-hosted voicemail service and a network-hosted simultaneous ringing service;

FIG. 2 is a block diagram of a prior art VoIP network in which a conflict can arise between an endpoint-hosted music-on-hold service and a network hosted conferencing service;

FIG. 3 is a block diagram of an embodiment of the present invention in which the conflict in FIG. 1 between the endpoint-hosted voicemail service and the network-hosted simultaneous ringing service is avoided; and

FIG. 4 is a block diagram of an embodiment of the present invention in which the conflict in FIG. 2 between the endpoint-hosted music-on-hold service and the network-hosted conferencing service is avoided.

### DETAILED DESCRIPTION

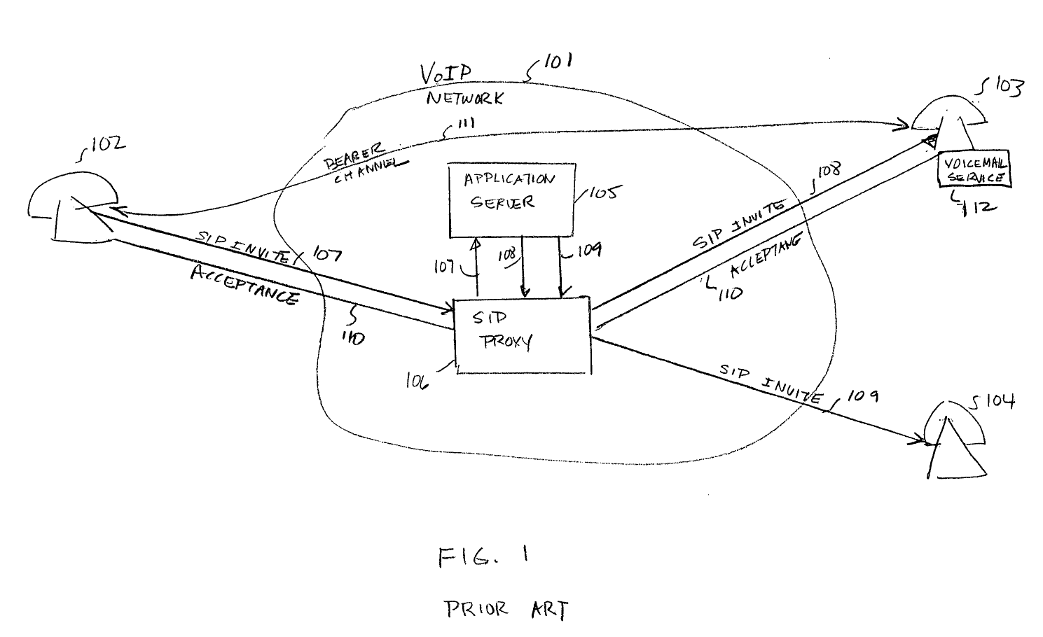

With reference to FIG. 1, a prior art VoIP network 101 is shown to which illustrative VoIP endpoints 102, 103 and 104 are connected. The use of a SIP signaling protocol is assumed in this embodiment. For purposes of illustration, it is assumed that endpoint 103 is subscriber Bob's home telephone and that endpoint 104 is subscriber Bob's office telephone. In order to illustrate a potential conflict between a network-hosted service and an endpoint-hosted service, subscriber Bob is assumed to subscribe to a network-hosted “simultaneous ringing” service running on application server 105 in the network. In accordance with such a service, when subscriber Alice at endpoint 102 calls subscriber Bob at his home endpoint 103, a SIP INVITE is sent by endpoint 102 to SIP proxy 106 in the network. SIP proxy 106 determines from a network database lookup (not shown) that the called endpoint 103 subscribes to a network-hosted simultaneous ringing service and sends a message to the application server 105 in the network running that service. Application server 105 responds to that message by providing SIP proxy 106 with the identity of the multiple endpoints to be simultaneously rung. SIP proxy 106 then sends out multiple SIP INVITE messages to those endpoints, which in this example are to Bob's home endpoint 103 and his office endpoint 104. When Bob answers either ringing endpoint 103 or 104, a call acceptance message is sent back to SIP proxy 106, and thence back to Alice's endpoint 102. Upon the acceptance of the SIP INVITE message at one of the endpoints, ringing is ended at the other simultaneously ringing endpoint, thereby precluding anyone from answering the incoming call at the other endpoint. Once Alice's originating endpoint 102 receives the acceptance message from SIP proxy 106, a bearer channel is set up directly between Alice's endpoint 102 and the first particular endpoint of Bob's that answered the call.

A conflict between services will arise if Bob's home endpoint 103, for example, is running an endpoint-hosted integrated voicemail service, which automatically answers the ringing endpoint after a predetermined number of rings. Thus, if Bob is at his office location but doesn't answer his ringing endpoint 104 before the voicemail service on simultaneously ringing home endpoint 103 is invoked, then a bearer channel will be established between Alice's calling endpoint 102 and Bob's answered home endpoint 103, thereby disabling Bob from answering the incoming call from office endpoint 104. Thus, the purpose of Bob's simultaneous ringing service is defeated since he has been precluded from answered the ringing endpoint at which he is currently located. Thus, for this illustrative example, a conflict exists between the network-hosted simultaneous ringing service subscribed to by Bob that is associated with Bob's endpoints 103 and 104, and the endpoint-hosted integrated voicemail service that is running on Bob's home endpoint 103.

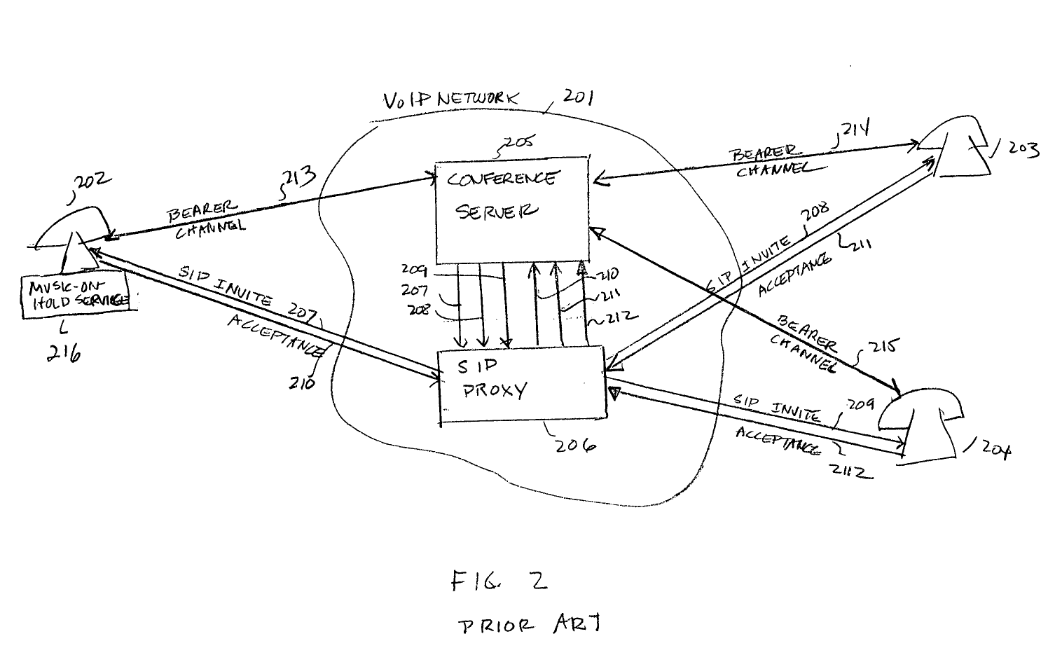

FIG. 2 shows another illustrative example of a conflict in the prior art between a network-hosted conference calling service and an endpoint-hosted music-on-hold service in a VoIP 201 network to which illustrative endpoint terminals 202, 203 and 204 are connected. A conference server 205 invites conference participants to a conference by sending SIP INVITE messages to each endpoint terminal through SIP proxy 206. SIP proxy 206 forwards the SIP INVITE messages to the participants at their respective endpoints 202, 203 and 204. When a SIP INVITE is accepted by an endpoint, the accepting endpoint sends a message back to SIP proxy 206, which informs the conference server 205 of the acceptance. A bearer channel is set then up directly between conference server 205 and each of the endpoints 202, 203, and 204 that has responded to and accepted the SIP INVITE, allowing a conference to proceed amongst the participants at those endpoints. Endpoint 202 may also be also running, for example, an endpoint-hosted music-on-hold service. During an ongoing conference, if the participant at that endpoint 202 places the conference call on hold, the endpoint-hosted music-on-hold service running on that endpoint will be invoked. The remaining conference participants on endpoints 203 and 204 will then be disturbed by the music emanating from endpoint 202, which still remains part of the conference call. Thus, a conflict exists between the network-hosted conferencing service and the endpoint-hosted music-on-hold service running on endpoint 202 when that music-on-hold service is invoked.

In order to avoid conflicts between a network-hosted service and an endpoint-hosted service in a VoIP network, an embodiment of the present invention determines whether a conflict exists and then takes action to avoid a conflict by instructing one or more of the network-hosted and/or endpoint-hosted services to not run or to run only with certain restrictions so as to avoid the conflict.

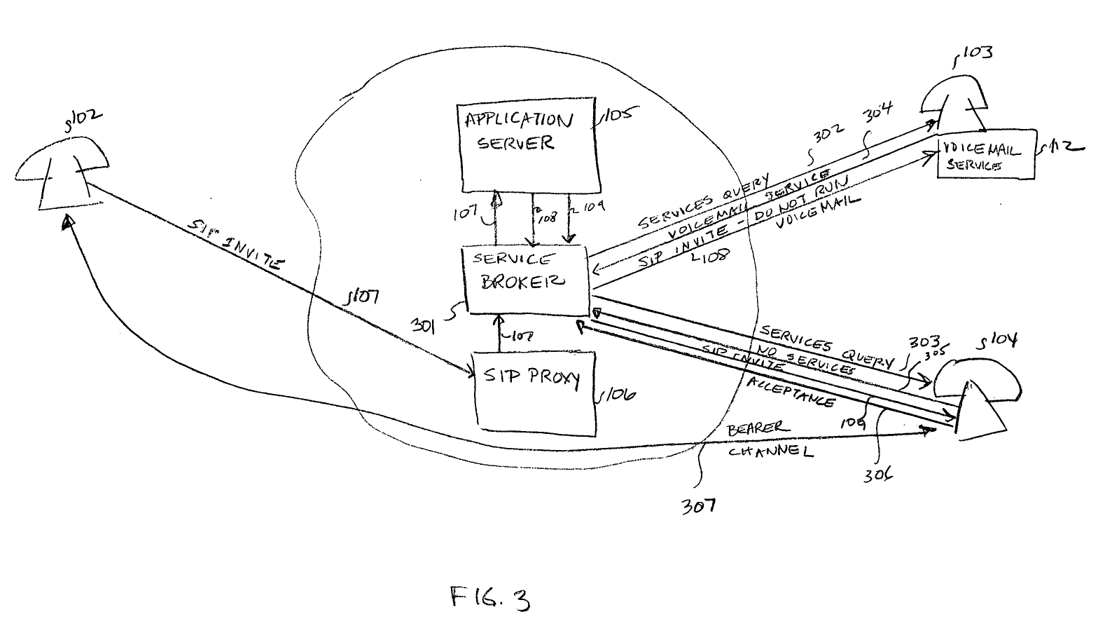

In the embodiment shown in FIG. 3, conflicts are prevented between the network-hosted simultaneous ringing service and the endpoint-hosted integrated voicemail service, which was discussed above in connection with FIG. 1. In FIG. 3, the same reference numerals are used for those elements also commonly present in FIG. 1. In this embodiment, a service broker 301 within VoIP network 101 acts as an intermediary between the application server 105 and the called endpoints 103 and 104. Service broker 301 is shown in this embodiment as being an entity that is separate from SIP proxy. It could, however, be integrated with the SIP proxy. When a call is initiated by Alice at endpoint 102 to Bob's home endpoint 103, the service broker 301 determines that both an endpoint-hosted voicemail service is running on that called endpoint 103, and that the called endpoint also subscribes to a network-hosted simultaneous ringing service. The service broker 301, determining a conflict would arise if both services were to run simultaneously, sends a message to the voicemail service running on endpoint 103 to ignore the incoming call. More specifically, when Alice at her endpoint 102 initiates a call to Bob's endpoint 103, a SIP INVITE is sent to SIP proxy 106. Proxy 106 forwards the SIP INVITE message to service broker 301, which knows from a network database (not shown) that the call endpoint 103 subscribes to a simultaneous ringing service. Service broker 301 then forwards the SIP INVITE message to application server 105, which in turn simultaneously responds to service broker 301 with a SIP INVITE message directed to Bob's home endpoint 103 and a SIP INVITE message directed to Bob's office endpoint 104. Before sending the SIP INVITE message to both endpoints, however, service broker 301 queries both endpoints 103 and 104 about the types of endpoint-hosted services that they are running. Upon receiving a response from endpoint 103 that indicates that it is running an endpoint-hosted voicemail service, service broker 301 determines that a conflict exists between the network-hosted simultaneous ringing service and the endpoint-hosted voicemail service. To avoid the conflict, service broker 301 includes an instruction with the SIP INVITE message sent to endpoint 103 for the voicemail service running thereon to ignore this presently incoming call. Thus, when the SIP INVITE messages simultaneously sent by service broker 301 to Bob's home endpoint 103 and Bob's office endpoint 104, both phones ring until one of the endpoints answers the incoming call without the voicemail service on endpoint 103 cutting off the ringing on endpoint 104 before Bob can answer the call from endpoint 104.

Although, FIGS. 1 and 3 show Bob's called endpoints 103 and 104 being located in the same domain at the Alice's calling endpoint 102, in actuality Alice's calling endpoint 102 and Bob's called endpoints 103 and 104 may be located in different domains. In this arrangement, the SIP proxy in Alice's calling endpoint's domain forwards the SIP INVITE message sent from endpoint terminal 102 to a SIP proxy in Bob's endpoints' domain where it is forwarded to an application server in that domain. A service broker in Bob's domain then determines whether the network-hosted service or services to which Bob subscribes are in conflict with any of the endpoint-hosted services running on any of his endpoint terminals.

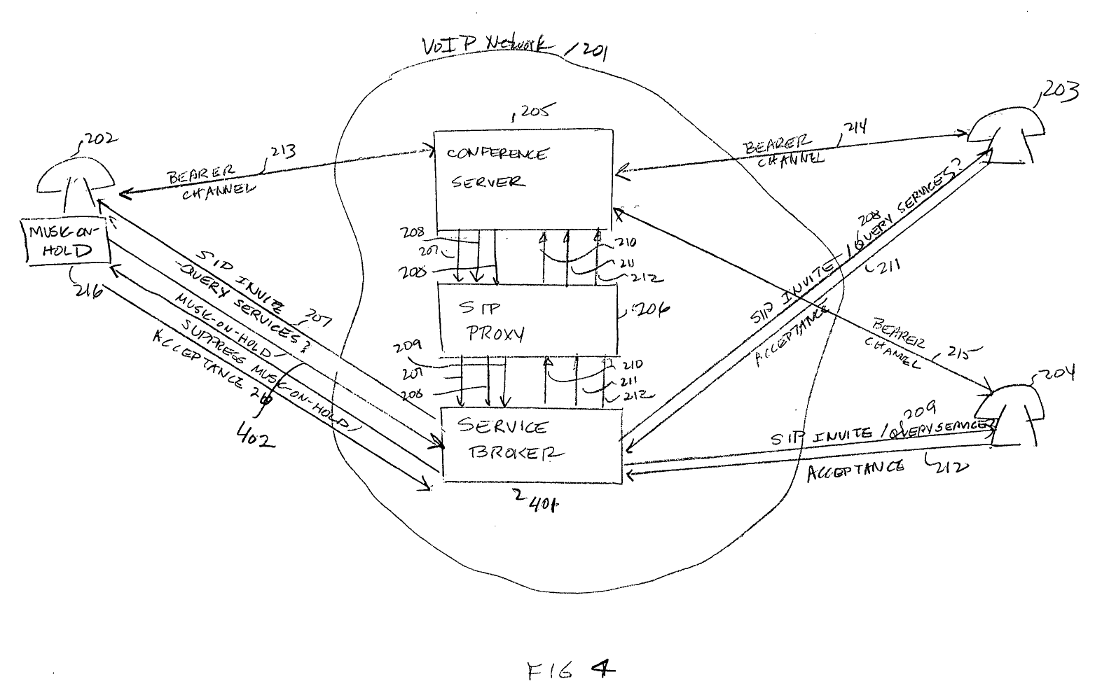

FIG. 4 shows how an embodiment of the present invention can prevent conflicts between the above-described endpoint-hosted music-on-hold service and the network-hosted conferencing service shown illustratively in FIG. 2 and discussed above. In FIG. 4, the same reference numerals are used for elements also present in FIG. 2. In this embodiment, the conference server 205 invites conference participants to a conference by sending SIP INVITE messages to endpoints 202, 203 and 204 through SIP proxy 206. Rather than forwarding each SIP INVITE directly to each endpoint, SIP proxy 206 first forwards each SIP INVITE through an intermediary service broker 301, which in turn forwards the SIP invite to each endpoint together with a request querying each endpoint as to which endpoint-hosted services are running. The service broker 301, in response to receiving an indication from endpoint 202 that it is running a music-on-hold service, determines that a conflict exists between that service and the network-hosted conferencing service and thereupon instructs endpoint 202 to suppress, during the current conference call, running of that endpoint-hosted music-on-hold service so as to avoid a conflict with the conferencing service. Alternatively, in the middle of an ongoing conference call, endpoint 202 could announce to the service broker 301 that it is going to activate a new endpoint-hosted service, such as music-on-hold. The service broker would then make a determination whether a conflict exists with the ongoing network-hosted conference service and instruct endpoint 201 to either run or not run that endpoint-hosted service. That determination could, for example, be made based on the number of participants currently involved in the conference call. Thus, if only users at endpoints 202 and 203 are involved in the conference call at the time that the user at endpoint 202 goes on hold, then the SMF within the service broker may decided to not interfere with the running of the music-on-hold service on endpoint 202 since running that endpoint-hosted service at that time will not create an interference to multiple participants on an ongoing conference call. On the other hand, if participants at endpoints 202 and 203 are involved in the conference call at the time that the user at endpoint 202 goes on hold, then the SMF within service broker 301 will decide that a conflict is present and instructs endpoint 202 to suppress its music-on-hold service when the user at that endpoint goes on hold.

An example of a mechanism that can be used to implement the above-described methodology for preventing conflicts between network-hosted services and endpoint-hosted service is the SIP Session Policy Framework, which is being standardized by the SIP community to enable network entities to establish polices that guide the interaction between endpoints and network entities. The framework is very flexible in that it can be used with arbitrary policies, specified as “policy packages” in separate standards. When applied to service mediation, the policy framework could be used to inform endpoints which services should not be invoked in order to avoid interaction conflicts with network-hosted services. The policy framework also provides for a mechanism for endpoints to expose aspects of their session description to the network. In the context of service mediation, this mechanism could be used as a service discovery mechanism in that endpoints could inform the service broker of their intention to invoke a certain service during a particular session. The policy framework provides for session policies to govern a particular session or all sessions that are set up during a specific time period. Session policies may be renegotiated while a session is still in progress. These features will enable a service broker to prevent interaction conflicts in a dynamic fashion. For example, the service broker could instruct an endpoint to terminate a running endpoint-hosted service when a particular network event triggers the invocation of a network-hosted service.

In a particular embodiment in which the service broker is integrated with a SIP proxy, all incoming and outgoing SIP messages for endpoints in a particular domain will pass through the service broker providing the SMF. It can be assumed that the service broker is aware of the network-provided services, which are active for a particular call. The determination of whether or not a network-provided service is active for a call is commonly based on the end user's service subscription information. In IMS-based (IP Multimedia Subsystem) networks, this information can be obtained from service invocation rules such as the Initial Filter Criteria. It is also assumed that the service broker providing the SMF can coordinate network-provided services to the extent necessary to prevent service interaction conflicts.

In order to discover endpoint-provided services that are active for a current call, the session specific policy framework can be used as follows. In order to initiate the policy download, the service broker inserts a ‘Policy-Contact’ header into SIP INVITE messages, as per the session policy specification. That inserted “Policy-Contact” header points to a policy server controlled by the service broker and may be physically co-located with the service broker (not shown).

Upon receiving a SIP message containing a “Policy-Contact” header, the endpoint establishes a channel to the specified policy server. The endpoint then sends information about the current session over a policy channel to the policy server. For purposes of service mediation, the endpoint sends information regarding currently active endpoint services to the policy server. In its simplest form, this information may only consist of a list of zero or more unique service identifiers, each representing an active endpoint-provided service for the current session. The endpoint may also send other data to the policy server to aid the service broker in determining any potential interaction conflicts. This includes service version/release information as well as service configuration data. In cases where the service broker does not recognize the endpoint-provided service(s) (e.g., when the endpoint is running a user-developed application), the endpoint may also send general service classification or service behavior information to the policy server.

Upon receiving information regarding active services on the endpoint, the policy server relays this information to the service broker. The service broker, running the SMF, can then make an informed decision as to whether or not an interaction conflict will occur among the currently active endpoint-provided and network-provided services. If a conflict can occur, the service broker will choose an appropriate conflict resolution strategy. If the selected conflict resolution strategy involves the suppression of an endpoint-provided service, then the service broker instructs the policy server to respond to the endpoint with a policy document. This policy document requests the endpoint to suppress the execution of the identified endpoint service.

The base format for policy documents is specified through an XML schema in the currently being developed SIP session policy framework. In order to accommodate service mediation, an extension to the base policy format is proposed. At minimum, the policy format needs the SMF within the service broker to be able to specify one or more endpoint-provided services to be suppressed by the endpoint. More complex policy formats will advantageously enable fine-grained service coordination to be achieved, e.g., by controlling the behavior of a particular endpoint service via parameters.

The policy framework specification also supports policy updates for an existing session. As applied to service mediation, the SMF within the service broker may need to send policy updates to the endpoint if: 1) the status of a network-provided service changes during a session, and 2) the resulting conflict resolution strategy requires the coordination of an endpoint-provided service.

Session-independent policies may also be used for the discovery and coordination of endpoint-provided services in a similar fashion as session-specific policies, but they are less relevant due to their static nature. Under some circumstances, however, the use of session-independent policies may be more efficient, e.g., in cases where the service broker detects interaction conflicts between services that are active for all calls.

The foregoing therefore merely illustrates the principles of the invention. It will thus be appreciated that those skilled in the art will be able to devise various arrangements, which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views illustrating the principles of the invention. The functions of the various elements shown in the figures, including functional blocks labeled as “servers” or “proxies” may be provided through the use of dedicated hardware as well as hardware capable of executing software in association with appropriate software.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicants thus regard any means which can provide those functionalities as equivalent as those shown herein.

The invention claimed is:

1. A method in a Voice-over-IP (VoIP) network to which an intelligent VoIP endpoint is connected, the method comprising the steps of:
determining whether within a session involving the VoIP endpoint a conflict could arise between an endpoint-hosted service running on the intelligent VoIP endpoint and a network-hosted service subscribed to by the intelligent VoIP endpoint; and
if a determination is made that a conflict could arise, initiating a conflict resolution strategy so as to avoid the conflict.

2. The method of claim 1 wherein the step of initiating a conflict resolution strategy comprises suppressing the endpoint-hosted service and/or the network-hosted service in a predetermined manner.

3. The method of claim 2 wherein the step of initiating a conflict resolution strategy comprises instructing the endpoint-hosted service not to run.

4. The method of claim 2 wherein the step of initiating a conflict resolution strategy comprises instructing the endpoint-hosted service to run with certain restrictions.

5. The method of claim 2 wherein the step of initiating a conflict resolution strategy comprises instructing the network-hosted service not to run.

6. The method of claim 2 wherein the step of initiating a conflict resolution strategy comprises instructing the network-hosted serviced to run with certain restrictions.

7. The method of claim 1 further comprising the step of determining what services the intelligent VoIP endpoint is capable of running.

8. The method of claim 7 wherein the step of determining what services the intelligent VoIP endpoint is capable of running is determined in response to an SIP INVITE message sent to the intelligent VoIP endpoint.

9. The method of claim 1 wherein if the network-hosted service is invoked during the session and a determination is made that a conflict could arise between that network-hosted service and the running endpoint-hosted service, then sending a message to the intelligent VoIP endpoint to terminate the endpoint-hosted service.

10. Apparatus for use in a Voice-over-IP (VoIP) network to which an intelligent VoIP endpoint is connected comprising:
means for determining whether within a session involving the VoIP endpoint a conflict could arise between an endpoint-hosted service running on the intelligent VoIP endpoint and a network-hosted service subscribed to by the intelligent VoIP endpoint; and
means for initiating a conflict resolution strategy so as to avoid a determined conflict if the means for determining determines a conflict could arise.

11. The apparatus of claim 10 wherein the means for initiating a conflict resolution strategy suppresses the endpoint-hosted service and/or the network-hosted service in a predetermined manner if the means for determining determines a conflict could arise.

12. The apparatus of claim 11 wherein the means for initiating a conflict resolution strategy instructs the endpoint-hosted service not to run if the means for determining determines a conflict could arise

13. The apparatus of claim 11 wherein the means for initiating a conflict resolution strategy instructs the endpoint-hosted service to run with certain restrictions if the means for determining determines a conflict could arise.

14. The apparatus of claim 11 wherein the means for initiating a conflict resolution strategy instructs the network-hosted service not to run if the means for determining determines a conflict could arise.

15. The apparatus of claim 11 wherein the means for initiating a conflict resolution strategy instructs the network-hosted serviced to run with certain restrictions if the means for determining determines a conflict could arise.

16. The apparatus of claim 10 further comprising means for determining what services the intelligent VoIP endpoint is capable of running.

17. The apparatus of claim 16 wherein means for determining what services the intelligent VoIP endpoint is capable of running determines the services in response to an SIP INVITE message sent to the intelligent VoIP endpoint.

18. The apparatus of claim 10 wherein if the means for determining whether a conflict could arise determines that a conflict could arise with the endpoint-hosted service when a network-hosted service is invoked during the session, then the means for initiating a conflict resolution strategy sends a message to the intelligent VoIP endpoint to terminate the endpoint-hosted service.
